(19) United States
(12) Patent Application Publication
(10) Pub. No.: US 2024/0410410 A1
(43) Pub. Date: Dec. 12, 2024

(54) SELF-PIERCING RIVET

(71) Applicant: Atlas Copco IAS UK Limited, Flintshire (GB)

(72) Inventors: Samuel Williams, Flintshire (GB); Jordan Syme, Flintshire (GB); Paul Briskham, Flintshire (GB)

(21) Appl. No.: 18/698,268

(22) PCT Filed: Sep. 28, 2022
(86) PCT No.: PCT/GB2022/052453

§ 371 Date: Apr. 3, 2024

(30) Foreign Application Priority Data
Oct. 5, 2021 (GB) 2114261.7

(51) Int. Cl. F16B 19/08; B21J 15/02

(52) U.S. Cl. CPC F16B 19/086; B21J 15/025

(57) ABSTRACT

A self-piercing rivet (10) for joining high strength aluminium, the rivet comprising a head (12) and a shank (14) which is provided with a bore (16), wherein the shank has a diameter D1 of between 3.6 mm and 4.4 mm, and wherein a tip (28) of the shank is separated by a radial distance Tx of least 0.2 mm from an outer diameter of the shank.

### TECHNICAL FIELD

The present invention relates to a self-piercing rivet. The invention also relates to a riveting method, and to a joint formed using a rivet.

### BACKGROUND

Self-piercing rivets are well known and are used to join together layers of metal (including alloys). Self-piercing rivets are used for example to form joints between layers of aluminium. This is advantageous because, unlike steel, some combinations of aluminium cannot be welded together. Conventional aluminium is relatively soft, and self-piercing rivets are well suited to forming strong joints between layers of conventional aluminium.

It may be difficult to join high-strength aluminium alloys using self-piercing rivets. These high-strength alloys may have an ultimate tensile strength (UTS) prior to heat treatment which is 300 MPa or more (this may be referred to as T4 condition). The alloys may have a UTS after heat treatment which is 350 MPa or more (this may be referred to as T6 condition). The alloys may have a UTS of up to 600 MPa. The high-strength alloys may be in the AA6000 series, AA7000 series, or a combination of both. The higher strength of high-strength aluminium alloys compared with conventional aluminium means that greater force is needed to insert a rivet into the alloy. Conventional self-piercing rivets intended for low-strength aluminium applications may not be capable of withstanding this greater force. They may collapse or may result in undesirable joint characteristics such as poor interlock between joint layers. Another issue which may be seen is premature flaring of the rivet. That is, the rivet will begin to flare outwardly as it travels through a first layer of material being joined, and as a result will not properly penetrate into the second layer of material.

EP2514538 describes a method of joining high strength aluminium alloy which includes heating the alloy and thereby reducing its tensile strength before a rivet is inserted. Whilst this method may be effective, it requires additional equipment in order to provide the heating and also requires additional time.

It is an object of the present invention to provide a self-piercing rivet which overcomes or mitigates a problem associated with the prior art.

### SUMMARY OF INVENTION

According to a first aspect of the invention there is provided a self-piercing rivet for joining high strength aluminium, the rivet comprising a head and a shank which is provided with a bore, wherein the shank has a diameter D1 of between 3.6 mm and 4.4 mm, and wherein a tip of the shank is separated by a radial distance Tx of least 0.2 mm from an outer diameter of the shank.

Advantageously, the relatively large radial tip distance Tx (compared with conventional rivets) avoids premature flaring of the rivet, and the relatively narrow shank diameter (compared with conventional rivets) allows flaring of the rivet to be achieved without requiring a much smaller radial tip distance.

The radial distance Tx may be at least 0.165 mm+(0.01×effective length of the rivet).

The radial distance Tx may be up to 0.25 mm+(0.005×effective length of the rivet).

The shank may have a thickness LT of at least 0.8 mm.

A ratio of shank diameter/inner shank diameter D2/D1 may be at least 0.5.

The inner shank diameter D2 may be at least 1.8 mm.

A ratio of shank thickness/shank diameter may be greater than 0.66.

The self-piercing rivet may have a tip of the shank which does not include a flat ring which extends fully around the tip of the rivet.

The shank diameter D1 may be at least 3.4 mm+(0.0471×effective length of the rivet).

The shank diameter D1 may be up to 3.8 mm+(0.0471×effective length of the rivet).

A piercing end of the rivet may include a radiussed portion having a ratio of radius R2/shank thickness LT of at least 0.66.

According to a second aspect of the invention, there is provided a self-piercing rivet for joining high strength aluminium, the rivet comprising a head and a shank which is provided with a bore, wherein the shank has a diameter D1 of between 3.6 mm and 4.4 mm, and wherein a tip of the shank does not include a flat ring which extends fully around the tip of the rivet.

Advantageously, not having a flat ring allows better flow of workpiece material around the rivet tip According to a third aspect of the invention, there is provided a self-piercing rivet for joining high strength aluminium, the rivet comprising a head and a shank which is provided with a bore, wherein the shank has a diameter D1 of between 3.6 mm and 4.4 mm, further comprising any of the features of the first aspect of the invention.

According to a fourth aspect of the invention, there is provided a self-piercing rivet for joining high strength aluminium, the rivet comprising a head and a shank which is provided with a bore, wherein the shank has a diameter D1 of between 3.6 mm and 4.4 mm, and wherein the rivet head includes a substantially flat underside portion.

Advantageously, the substantially flat underside portion of the head allows the head to pressed against the workpiece. This allows lower insertion force to be used, compared to for example when a countersunk head is pushed into the workpiece.

The substantially flat underside portion of the head may extend radially by at least 0.15 mm.

The rivet head may have a thickness HT of up to 0.5 mm.

A radiussed transition between the rivet head and the shank may have a radius R1 of 0.6 mm or less.

The rivet head may have a diameter HD of 5.5 mm or less.

According to a fifth aspect of the invention, there is provided a joint formed in a workpiece comprising at least two layers of high strength aluminium alloy, wherein the joint is formed using a self-piercing rivet having a shank with a diameter D1 prior to insertion into the workpiece of between 3.6 mm and 4.4 mm.

Advantageously the diameter D1 may allow the joint to be formed using less force and with less likelihood of workpiece cracks (compared for example to joining high strength aluminium alloy using a 5 mm rivet). The joint may be formed with the workpiece at room temperature.

A tip of the shank may be separated by a radial distance Tx of least 0.2 mm from an outer diameter of the shank prior to insertion.

The rivet head may include a substantially flat underside portion prior to insertion.

According to a sixth aspect of the invention, there is provided a method of forming a joint comprising inserting a rivet into at least two layers of high strength aluminium, wherein the self-piercing rivet has a shank with a diameter of between 3.6 mm and 4.4 mm, wherein the workpiece is at room temperature and wherein the rivet is inserted into the workpiece using a force of 50 kN or less.

Features of different aspects of the invention may be combined together.

### BRIEF DESCRIPTION OF THE DRAWINGS

Some embodiments of the disclosure will now be described by way of example only and with reference to the accompanying drawings, in which:

FIGS. 1A-1C depict in cross-section a self-piercing rivet according to an embodiment of the invention;

FIGS. 2A-2C depict in cross-section a self-piercing rivet according to another embodiment of the invention;

FIGS. 3A-3C depict in cross-section a self-piercing rivet according to another embodiment of the invention;

FIG. 4 is a cross-section of a joint formed using a rivet according to an embodiment of the invention;

FIGS. 5A and 5B are a cross-section and a view from below of a joint formed using a conventional rivet prior art;

FIG. 6 is a cross-section of a joint formed using a rivet according to another embodiment of the invention;

FIG. 7 is a cross-section of a joint formed using a rivet according to another embodiment of the invention; and.

FIG. 8 is a cross-section of a joint formed using a rivet according to another embodiment of the invention.

### DETAILED DESCRIPTION

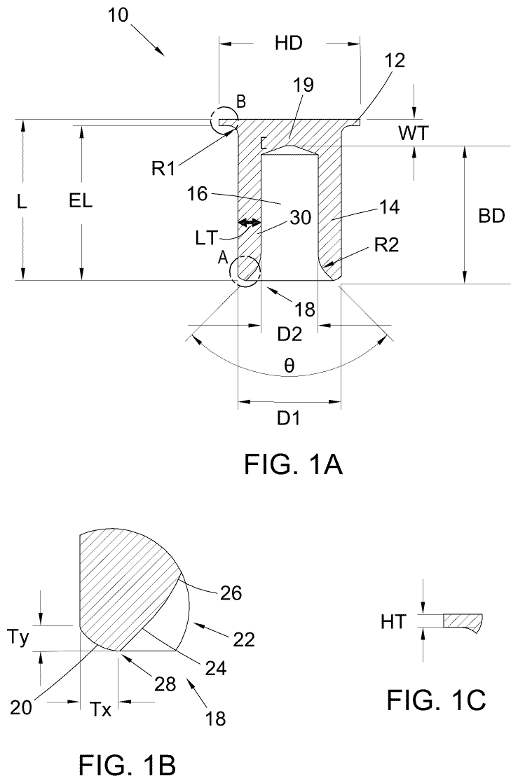

FIGS. 1A-1C depict in cross section a self-piercing rivet 10 according to an embodiment of the invention. The self-piercing rivet is substantially cylindrical, with a head 12 which extends radially outwards from a depending shank 14. The shank is partially hollow and defines a central bore 16. The shank has a piercing end 18 distal from the head.

Part of the head 12 of the rivet 10 is depicted in detail in FIG. 1C. From FIGS. 1A and 1C in combination it may be seen that the head 12 has a diameter HD of 5.5 mm and has a thickness HT of 0.25 mm. The head 12 has a substantially flat upper surface to which force is applied to insert the rivet 10 into a workpiece (not depicted). An upper end of the shank 14 flares outwardly with a radius R1 to meet with the underside of the head. The radius R1 is 0.4 mm. The remainder of the underside of the head 12 is substantially flat (i.e. it is not conical). The configuration of the head 12 differs from the head configuration of rivets that have previously been proposed for joining high strength materials such as high strength aluminium alloys, in that it has a smaller diameter (relative to the diameter of the shank 14), and includes a flat portion on the underside of the head. This is discussed further below.

The shank 14 has an outer diameter D1 of 4 mm and has an inner diameter D2 of 2.25 mm. This provides a thicker shank wall (relative to the shank diameter D1) than is seen in rivets that have previously been proposed for joining high strength materials such as high strength aluminium alloys. This is discussed further below.

The piercing end 18 of the rivet 10 is depicted in detail in FIG. 1B. The piercing end 18 comprises an outer portion 20 which is radiussed, and an inner portion 22 which comprises a conical part 24 and a radiussed part 26. The conical part 24 of the inner portion 22 meets the radiussed outer portion 20 at a tip 28 of the rivet. The radiussed part 26 of the inner portion 21 connects the conical part to a cylindrical inner part 30 of the rivet shank.

The tip 28 of the rivet is located 0.3 mm radially inwards from the outside diameter of the shank 14. This radial distance, labelled Tx, of the rivet tip 28 from the outside of the shank 14 is greater than the radial distance seen in conventional rivets designed for joining high strength materials. Unlike conventional rivets for high strength applications, the piercing end 14 does not include a flat portion (i.e. the rivet tip does not include a flat ring which extends fully around the tip of the rivet). It has conventionally been understood that a flat ring is needed at the tip of a rivet used for joining high strength materials. This is because it has been conventionally understood that a substantial cross-sectional area was needed at the rivet tip in order to avoid collapse of the rivet when travelling into high strength material. However, the inventors have determined that a flat ring is disadvantageous because it will reduce workpiece material flow velocity around the tip of the rivet—it is harder for workpiece material to flow around the rivet tip when a flat is present. This is particularly problematic if the flat is provided at the outer perimeter of the tip, because this forms a 90° angle with the shank, and it is difficult for workpiece material to flow around such an angle. When poor workpiece material flow occurs, this may cause excess material to sit below the tip of the rivet and may cause a poor quality joint to be formed. When a flat ring is not present, as in embodiments of the invention, this problem is avoided. In addition, forces which delay flaring of the rivet and forces which cause flaring of the rivet may be better balanced, such that flaring of the rivet occurs in the lowermost layer of a workpiece.

The radiussed outer portion 20 has a height Ty which will vary for different Tx values (a larger Tx will generally result in a larger Ty). In the depicted rivet, the Ty is up to 0.2 mm.

The radius of the radiussed outer portion 20 is free-formed during manufacture of the rivet, and as a result this radius may vary between rivets. Ty will generally be no more than 0.5 mm and typically no less than 0.1 mm).

The conical part 24 of the inner portion 22 subtends an angle θ of around 90° (e.g. between 80° and 100°). The radiussed part 26 of the inner portion 22 has a radius R2 of 1.2 mm.

The rivet 10 has an overall length L of 6.25 mm. Taken together, the shank 14 and the radiussed portion R1 have a length EL of 6 mm. This length EL may be referred to as the effective length of the rivet. The effective length of the rivet may be thought of the as the length of the part of the rivet that will be inserted into a workpiece when forming a joint.

The central bore 16 is a blind bore and terminates at a web 19 provided at the top of the rivet 10. The web 19 has a thickness WT of 1 mm. The web thickness WT is measured from an uppermost point of the bore 16 to the upper surface of the head 12. An upper end of the bore 16 of the depicted rivet 10 has a frustoconical shape. This shape is formed because the bore 16 is made using a drill. However, the shape at the top of the bore 16 may differ from the illustrated shape, for example if the rivet 10 is made using a different process. The rivet 10 may be made using cold forging. The upper end of the bore 16 may for example have a domed shape or some other concave shape.

The depth of the bore BD is 5.25 mm.

The rivet shank 14 has an inner diameter D2 of 2.25 mm. The thickness LT of the wall of the rivet shank 14 is 0.875 mm.

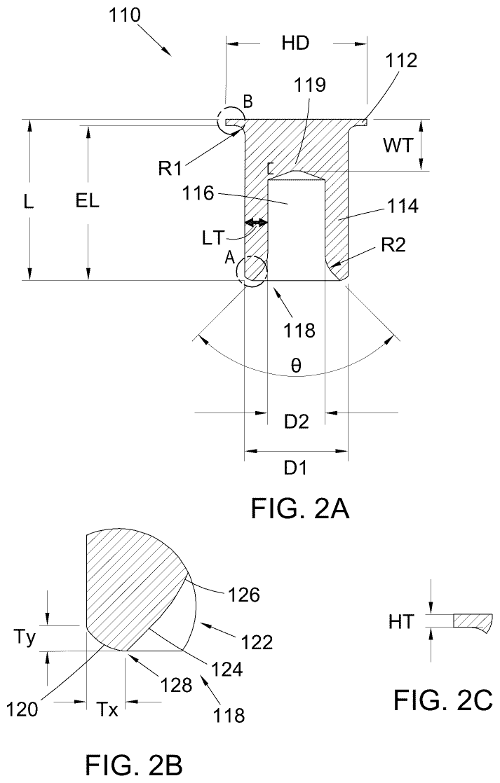

FIGS. 2A-2C depict in cross section a self-piercing rivet 110 according to another embodiment of the invention. Most of the dimensions of the self-piercing rivet correspond with those described above in connection with FIGS. 1A-1C and are not repeated in this description. However, the web 119 of the rivet 111 is thicker than the web 19 of the rivet 11 depicted in FIGS. 1A-C. The thickness WT of the web of the rivet depicted in FIGS. 2A-2C is 2 mm. As a result, although the total length L of the rivet 111 is the same as the rivet 11 in FIGS. 1A-C, the depth BD of the bore 116 is reduced. The bore depth BD of the rivet 111 is 4.25 mm. The bore depth BD can influence the flow of material being joined by the rivet and can influence flaring of the rivet, as is discussed further below.

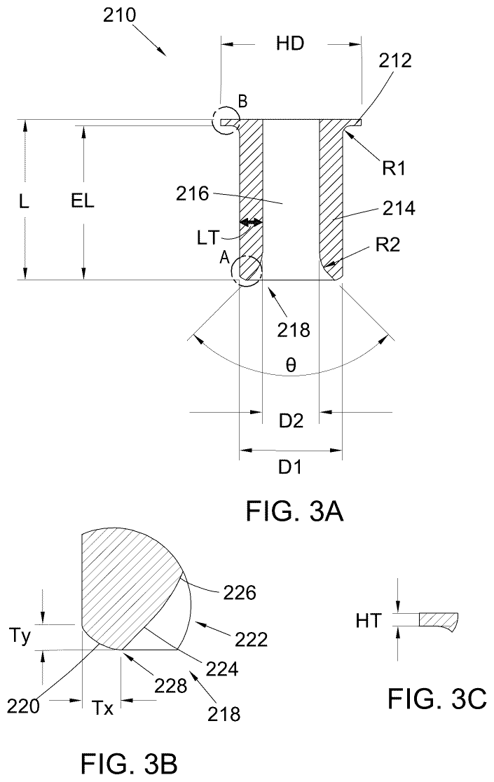

FIGS. 3A-3C depict in cross section a self-piercing rivet 210 according to another embodiment of the invention. Most of the dimensions of the self-piercing rivet correspond with those described above in connection with FIGS. 1A-1C and FIGS. 2A-2C, and are not repeated in this description. However, in this embodiment the shank 214 is fully hollow instead of being partly hollow. That is, the bore 216 extends fully along the length of the rivet 210. As a result, the head 212 is annular in shape rather than cylindrical. Other dimensions of the head 212 are the same as in preceding embodiments.

In depicted embodiments of the invention the outer diameter of the shank D1 is 4 mm. Previous attempts to join high strength aluminium alloys have focused around the use of a rivet with a 5 mm diameter shank or greater. It was thought that a shank diameter of 5 mm or more was needed in order to provide the rivet shank with sufficient strength to avoid buckling of the shank during insertion into high strength aluminium alloy (e.g. 6000 series or 7000 series). However, surprisingly, it has been found that high strength aluminium alloy can be joined using self-piercing rivets with a shank diameter of 4 mm without the shank buckling. This outcome is achieved at least in part because the smaller diameter of the rivet results in a reduction of joint material displacement, and thus the force required for rivet insertion is reduced.

In the figures depicting rivets according to embodiments of the invention the diameter D1 of the shank is 4 mm. In practice, a rivet having a shank diameter D1 of 4 mm±10% may be used, and such rivets may still advantageously join high strength aluminium alloys (or other high strength materials). The rivet shank diameter D1 may be between 3.6 mm and 4.4 mm.

The thickness LT of the wall of the rivet shank 14, 114, 214 is 0.875 mm (LT=(D1−D2)/2). The ratio of the inner shank diameter to outer shank diameter D2/D1 in the depicted embodiments is 0.56. A ratio of at least 0.5 may minimize the risk of the rivet shank buckling during rivet insertion (e.g. for a rivet diameter of 4 mm±10%). If the thickness LT of the shank wall is too great then the rivet bore 16, 116, 216 may not have enough volume to accommodate workpiece material during rivet insertion. The ratio of the inner shank diameter to outer shank diameter D2/D1 may be up to 0.65 (e.g. for a rivet having a 4 mm±10% shank diameter). It may be preferred to have a ratio D2/D1 of up to 0.58, as this may provide a bore volume which can accommodate workpiece material more easily than a larger ratio (and may provide a better joint). The inner shank diameter D2 may be at least 1.8 mm.

A prior art rivet intended for use with high strength materials would typically have a 5 mm diameter shank and a head diameter of 7.75 mm. This provides a head diameter to shank diameter ratio HD/D1 of 1.55. In the depicted embodiments of the invention the ratio HD/D1 is 1.375 (5.5/4). Thus, the head diameter is less than would be expected for a rivet with a 4 mm diameter shank. In addition, the head thickness HT is thinner than is conventional. The head does not have a chamfer (conical shape) which extends to the outer perimeter of the head or a radius which extends to the outer perimeter of the head. Instead, the head profile has a flat underside portion. In other words, an outermost portion of the head has a flat underside. The head configuration is different to what is conventionally understood to be required. The conventional understanding is that when designing a rivet to be inserted into high strength material, the head needs to be made very strong in order to avoid it breaking off from the shank during insertion into the workpiece (this can happen due to the very large rivet insertion force that is applied). In rivets according to embodiments of the invention a different approach has been taken. Rivet insertion force is reduced and this allows a thinner head to be used. The shape of the head (the head profile) is in part responsible for reducing the rivet insertion force, as is explained below. Embodiments of the invention may have a substantially flat underside portion. The term “substantially flat” may be understood to mean generally perpendicular to an axis of the rivet shank.

The head has a flat lower surface which is not pressed into the high strength aluminium upper layer of a joint but instead merely presses against (or comes into contact with) the high strength aluminium upper layer. As a result, the high force normally applied to push the head into the high strength aluminium upper layer of the workpiece is not needed. Taking the example of a chamfered (conical) head of a conventional rivet, when the chamfered portion of the head is driven into the high strength aluminium upper layer of a workpiece, this requires considerable force. Because the head of embodiments of the invention is not pressed into the high strength aluminium upper layer of the workpiece, less force is need and the head does not need to be as strong. The head can therefore be made thinner. Because the head is thin and has a flat lower surface, it extends by only a small thickness above the surface of the high strength aluminium upper layer (e.g. 0.25 mm). This in turn means that there is no need to push the head into the high strength aluminium upper layer (it does not project significantly from the upper layer). This virtuous combination of head features and resulting effects is opposite to the conventional approach of trying to make the head stronger. The head may for example have a thickness of up to 0.5 mm.

In this document, a statement that the head of the rivet is not pushed into the upper layer of a joint may be interpreted as meaning that a flat underside of the head does not penetrate into the joint upper layer. A radiussed portion of the head which is radially inward of the flat underside may penetrate into the joint upper layer.

In some joints the upper layer have an upper layer which is formed from conventional (soft) aluminium (i.e. aluminium which is not high strength aluminium). Where this is the case, the head may be pushed into the conventional aluminium. Such a joint may be referred to in the vehicle industry as having a soft body side (the body side being the exterior of the vehicle). The force required to push the rivet head into the conventional aluminium may be relatively low (e.g. less than 50 kN) because the diameter of the head is smaller than for a conventional rivet.

The radius R1 which connects the head 12 to the shank 14 is relatively small (in the depicted example it is 0.4 mm). This advantageously provides a transition from the shank to the head which is curved and thus provides strength and manufacturability, but at the same time is a small radius transition such that only a small amount of material of the workpiece needs to be displaced in order for the underside of the head 12 to come into contact with the workpiece. The radius R1 may for example be up to 0.65 mm. A ratio R1/HD of the radius R1 to the head diameter HD in the depicted examples is 0.07 (0.4/5.5). The ratio R1/HD may for example be up to 0.15.

The flat underside portion of the head 12 may extend radially by at least 0.15 mm, preferably by at least 0.3 mm.

The diameter of the head HD is 5.5 mm and the diameter of the shank is 4 mm. As noted further above, this gives a smaller ratio of head diameter to shank diameter HD/D1 than is conventionally seen in rivets intended to join high strength materials. This smaller ratio is desirable because some setting force is still needed to press the head 12 against the workpiece, even if the head does not penetrate significantly into the workpiece. This setting force is increased for a larger head diameter. According to conventional understanding, a relatively large head diameter is needed in order to provide a sufficiently large interlock between the rivet and the workpiece. However, the inventors have noted that a smaller interlock may be used when joining high strength aluminium alloys. This is because it is harder to pull a rivet through a high strength material than for example through conventional aluminium, and thus a smaller interlock may provide the same strength of joint. In this example, a head-side interlock of 0.75 mm is sufficient to form a strong joint. A head-side interlock of as little as 0.1 mm may be used.

As noted above, the head configuration of a rivet according to embodiments of the invention reduces the force which is required to insert the rivet into the workpiece. This is advantageous because the force applied by a rivet insertion tool contributes to wear and tear of that tool and consumables such as punches. The reduced force has the effect of extending the lifetime of the tool and prolonging the life of consumables. A further advantage is that the reduced force will provide reduced residual rivet stress in a joint formed by the rivet. Typical forces required to insert a conventional 5 mm rivet into high strength aluminium alloy are in the range 65-75 kN. Embodiments of the invention may use a force of 50 kN or less (e.g. force in the range 40-50 kN).

The piercing end 18 of the rivet 10 has a configuration which differs from prior art configurations. The conventional understanding is that a very sharp rivet tip is required in order to pierce effectively the upper layer of a workpiece formed from high strength aluminium alloy. In this context the term “sharp” means that the radial distance Tx between the tip and the outer shank diameter is 0.1 mm or less. However, the sharper a rivet is, the more likely it is to flare earlier on during rivet insertion. This is undesirable because in order to form a strong joint the rivet should not flare significantly when passing through the upper layer (or layers) of a workpiece and should instead flare when in the lowermost layer of the workpiece. This is so that the rivet provides an interlock which is effective in holding the layers of the workpiece together. It had been thought that in order to join high strength aluminium alloy a sharp rivet tip was needed, in combination with a strong pre-clamp on the rivet setting tool to hold layers of the workpiece together. This was so that flaring of the rivet in the upper layer of a workpiece would not cause a gap to be formed between the upper and lower layer of a workpiece (providing a defective joint). However, rivets according to embodiments of the invention have a blunter tip and thereby avoid this problem, whilst at the same time providing sufficient flaring to form a good joint.

The radial distance Tx between the tip 28 and the outer shank diameter in embodiments of the invention is at least 0.2 mm, preferably at least 0.25 mm. A radial distance Tx of 0.3 mm provides particularly good results. This relatively blunt tip provides flaring in the lower layer of a workpiece without significant flaring in the upper layer of a workpiece.

One reason for this is that the rivet shank 14 has a narrower diameter than is conventionally used and as a result less force is needed to achieve rivet flaring).

The radial distance Tx may have a minimum value of:

(EL×0.01)+0.165 mm

The radial distance Tx may have a maximum value of:

(EL×0.005)+0.25 mm

Providing a radial distance which falls within this range may provide desired flaring in a lowermost workpiece whilst avoiding premature flaring. The above range may apply for rivets having an effective length of 3.5 mm or more. The above range may apply for rivets having an effective length of up to 12 mm. As may be seen from the above, the minimum and maximum radial distance Tx increases as the effective length EL of the rivet increases. This is because less sharpness is needed to flare the rivet when it is longer.

The shank diameter D1 may have a value which depends upon the effective length EL of the rivet.

The minimum shank diameter D1 may have a value of:

(EL×0.0471)+3.4 mm

The maximum shank diameter D1 may have a value of:

(EL×0.0471)+3.8 mm

Thus, the minimum shank diameter D1 may be 3.6 mm when the effective length EL of the rivet is 3.5 mm. The maximum shank diameter may be 4.4 mm when the effective length of the rivet is 12 mm. A longer shank will be less strong than a shorter shank, and so will flare more easily (and vice versa). This is why the maximum shank diameter D1 is linked to the effective length EL by the above formulas.

The radius R2 of the radiussed part 26 of the shank inner portion 22 is 1.2 mm. This relatively large radius promotes flaring of the rivet (compared with a smaller radius). This may help to balance out a tendency for the rivet to flare less due to the rivet tip being blunter than is conventional. The thickness of the shank LT is 0.875 mm. This gives a ratio LT/R2 of 0.73. This ratio is larger than is used in conventional rivets (a typical conventional ratio LT/R2 is between 0.5 and 0.6). In embodiments of the invention the ratio LT/R2 may be greater than 0.7 (e.g. greater than 0.66). If a sharper tip and a thinner shank were used in connection with a relatively large R2 such as 1.2 mmm, then this could cause instability of the rivet (e.g. inconsistent flaring) when inserted into high strength materials. However, this instability is avoided by embodiments of the invention via the use of a blunter tip and thicker shank (compared with a conventional rivet). A radius R2 of at least 1 mm is preferred in order to promote flaring. A radius R2 of up to 2 mm may be used (e.g. for rivets with an effective length EL up to 6 mm).

The conventional understanding of rivet design for joining high strength materials has been that a flat annular portion is required at the tip of the rivet. This is because it was previously understood that in the absence of that flat annulus, buckling of the rivet shank would occur and/or a poor quality joint would be formed. When a rivet tip according to an embodiment of the invention is used there is no need for a flat annulus to be provided for the rivet tip to include a flat annulus. This advantageously means that the rivet insertion force required is reduced.

An advantage provided by the narrower diameter of the rivet shank and rivet head compared with conventional rivets for joining high strength materials is that it allows narrower flanges to be joined than would otherwise be the case. This advantage is two-fold. Firstly, the reduced size of the rivet means that a smaller area is occupied by the rivet. Secondly, because the rivet interacts with a smaller area of workpiece material, the likelihood of a crack being formed in the material is correspondingly reduced. In general it is problematic to form a joint close to the edge of for example a flange because if a crack forms then this crack could propagate to the edge of the flange thereby destroying the joint. However, when the likelihood of a crack being generated is reduced, this allows a joint to be formed closer to the edge of that flange.

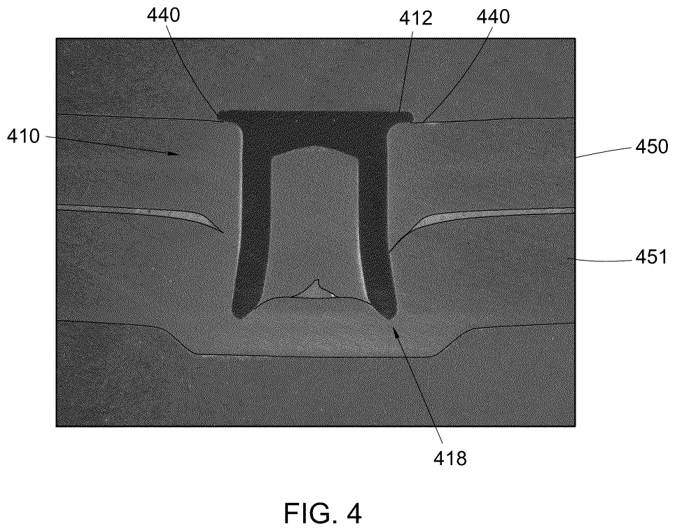

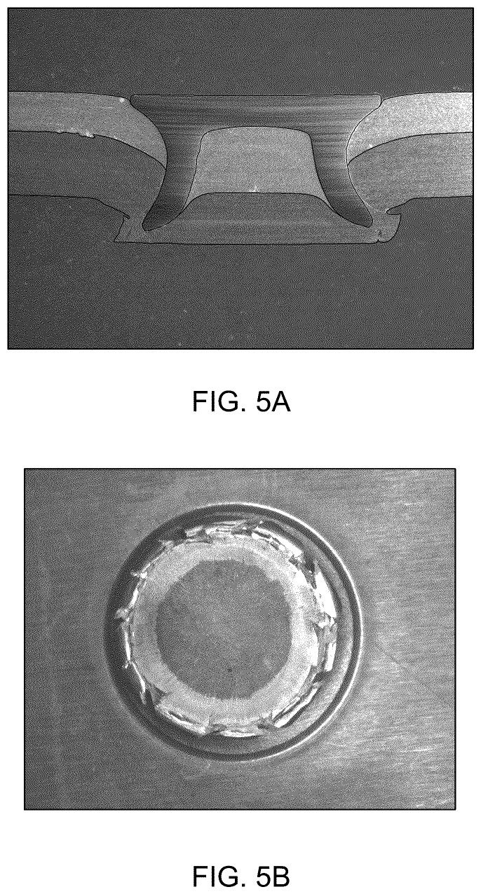

FIG. 4 shows in cross section a joint which has been formed using a rivet 410 according to an embodiment of the invention (the embodiment depicted in FIG. 1). The joint is formed in a workpiece consisting of a 2.5 mm thick upper layer of 7000 series aluminium alloy and a 3 mm thick lower layer of 7000 series aluminium alloy. As may be seen, the rivet has formed a strong joint which does not include defects that are seen in the prior art (see FIG. 5). The head 412 of the rivet is in contact with an upper surface of the upper layer 450. Because the head is in contact with the upper surface of the upper layer 450, and because the head is thin compared with prior art heads, it does not project significantly above the upper surface of the workpiece. In the depicted example the head is 0.09 mm above the upper surface of the workpiece. This is less than the thickness of the head (which is 0.25 mm). This is because the workpiece itself has moved down slightly in the vicinity of the rivet. This is not the same as pushing the head into the workpiece, as is done in the prior art. As may be seen, at positions 440 where the head meets the workpiece there is no significant bending of the workpiece around the profile of the head.

The joint was formed using a conventional die which did not include a pip or protrusion at its centre. As explained above, the die, in combination with the shape of the piercing end 418 of the rivet has promoted flaring of the rivet in the lower layer of the workpiece 451. As may be seen, significant flaring of the rivet did not occur in the upper layer of a workpiece 450. This is demonstrated by the fact that the portion of the rivet which is in the upper layer 450 of the workpiece is substantially cylindrical (i.e. does not project outwards significantly). In the lower layer 451 of the workpiece a significant degree of flaring has taken place. This provides a desired interlock between the layers 450,451 of the joint, thereby holding the layers together. In the depicted example the radially outward flaring of the rivet in the lower layer of the workpiece 451 is 0.2 mm. This 0.2 mm interlock of the rivet legs provides a sufficiently strong joint. In general, an interlock of at least 0.1 mm (e.g. up to 0.3 mm) in the lowermost layer of a joint may provide a strong joint.

FIGS. 5A and 5B depicts a joint formed between a 1.2 mm thick upper layer of 6000 series aluminium alloy (soft aluminium) and a 2 mm thick lower layer of 7000 series aluminium alloy (high strength aluminium) using a conventional (prior art) rivet. The rivet has a shank diameter of 5.3 mm. The depicted joint is a joint between soft aluminium and high strength aluminium because the inventors were not able to make a joint between two layers of high strength aluminium using a conventional rivet (the rivets merely failed and did not form a joint). As may be seen in FIGS. 5A and 5B, cracking of the lower layer of 7000 series aluminium alloy has occurred. The joint is defective and cannot be used. The large volume of the conventional rivet, due to its 5.3 mm diameter, is such that it needed to displace a large amount of high strength aluminium. In doing so it caused the high strength aluminum to crack. Embodiments of the invention avoid this problem. This may be achieved at room temperature, i.e. without having to heat the high strength aluminium.

An example of a poorly formed prior art joint in 7000 series aluminium alloy (EN AW-7075 T6) is shown on page 42 of Mechanisches Fugen 7000er Aluminiumlegierungen by Mathias Jackel, et al, published by Europäische Forschungsgesellschaft für Blechverarbeitung e.V. (ISBN 978-3-86776-539-8). As can be seen, fractures of the lowermost workpiece layer have occurred. The joint is poorly formed and is not of acceptable quality.

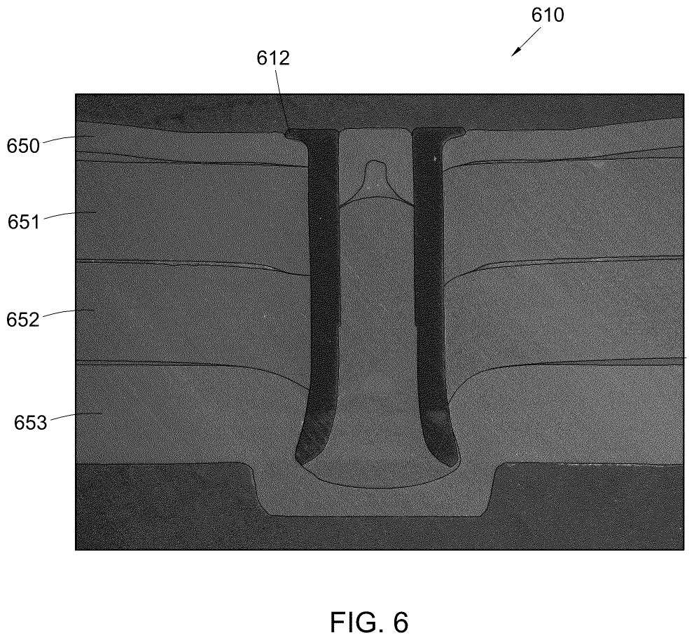

FIG. 6 depicts a joint formed in the 7000 series aluminium alloy using a rivet 610 according to an embodiment of the invention. In this case the rivet that was used is a tubular rivet, i.e. corresponding with the configuration depicted in FIGS. 3A-C. All of the dimensions of the rivet are as depicted and described above in connection with FIGS. 3A-C, except that the effective length EL of the rivet 610 is 11 mm. The workpiece comprises an upper layer 650 of soft aluminium (conventional aluminium), and three layers of high strength aluminium 651-653. When the rivet according to the embodiment of the invention is used premature flaring of the shank in is avoided, and flaring instead occurs towards the bottom of the workpiece, resulting in a good interlock. The joint has been formed effectively. The radially outward flaring of the rivet tip is 0.3 mm. This 0.3 mm interlock of the rivet legs provides a sufficiently strong joint. In general, an interlock of at least 0.1 mm in the lowermost layer of a joint may provide a strong joint. Because the upper layer 650 is formed from soft aluminium, the head 612 of the rivet has been pressed into the upper layer.

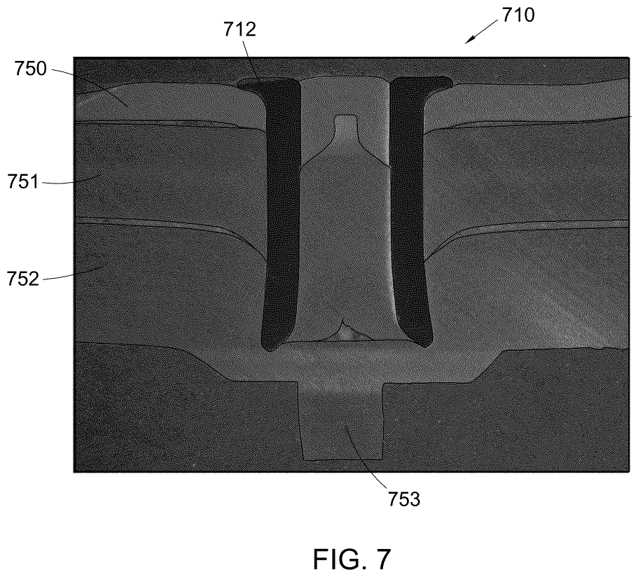

FIG. 7 depicts a joint formed in 6000 series aluminium alloy using a rivet 710 according to an embodiment of the invention. Again, this rivet has a configuration which corresponds with the configuration depicted in FIGS. 3A-C, i.e. it is a tubular rivet. The rivet 710 has dimensions which correspond with those depicted and described in connection with FIGS. 3A-C, except that the rivet an effective length EL of 7 mm. In this joint the workpiece consists of four layers 750-753. As with other joints formed using a rivet according to an embodiment of the invention, premature flaring of the rivet has been avoided and a good quality joint has been formed. The rivet head 712 has been partially pressed into the upper layer 750 which is formed from soft aluminium (conventional aluminium). In this joint a die with an opening at the centre of the die base has been used. Some of the lowermost layer 753 has passed through the opening to form a cylindrical protrusion at the bottom of the joint. Using a die with a central opening in the base may advantageously reduce the amount of workpiece material that must flow into the rivet bore or around the outside of the rivet when a joint is formed.

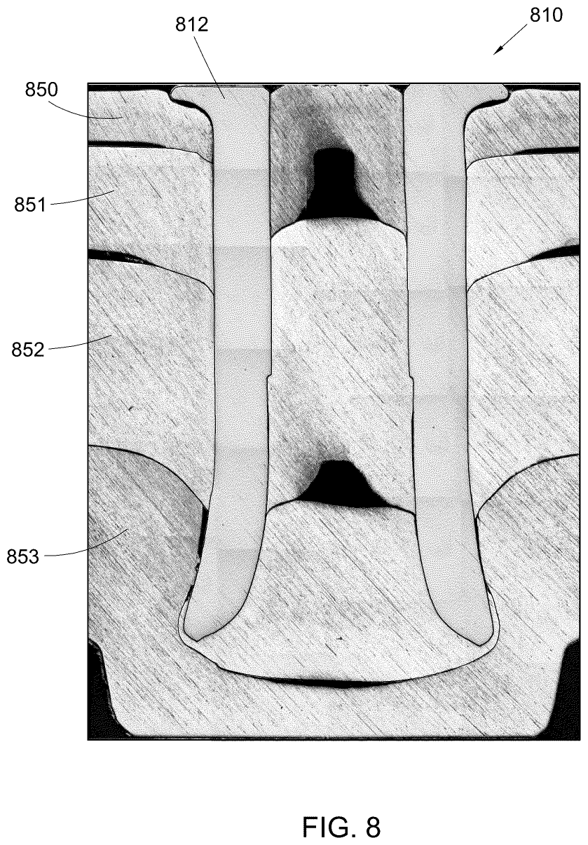

FIG. 8 depicts a joint formed in four layers 850-853 using a rivet 810 according to an embodiment of the invention. The top layer is soft aluminium (600 series aluminum), the two middle layers 851, 852 are high strength aluminum alloy (6000 series), and the bottom layer 853 is soft aluminium (600 series aluminum). A force of 45 kN force was used to insert the rivet 610 that was applied 6000 series aluminium alloy using a rivet according to an embodiment of the invention. Again, this rivet has a configuration which corresponds with the configuration depicted in FIGS. 3A-C, i.e. it is a tubular rivet and has the same dimensions as the rivet depicted and described in connection with FIGS. 3A-C. However, in this case the rivet has an effective length EL of 11 mm.

FIG. 8 has been stitched together using a number of microscopic images. The microscopic images were obtained in order to inspect the joint for cracks in the workpiece. No cracks were seen. This is advantageous because cracks are commonplace when joining high strength aluminium (as explained further above). Cracks are undesirable because they can propagate and introduce weakness into the joint.

When considering the behavior of closed versus tubular rivets, the impact of the web at the top of the rivet is important. When a rivet is inserted into a workpiece, workpiece material travels up inside the rivet bore. When workpiece material reaches the top of a closed bore, it cannot flow any further. As a result, pressure is applied into the lower layer of the workpiece. The lower layer of the workpiece will tend to flow radially outwards, and this promotes flaring of the rivet shank. Controlling the depth BD of the rivet bore (via selection of the web thickness) provides a degree of control of this effect. The effect may have less of an influence on flaring than the sharpness of the rivet tip (i.e. than Tx). However, it has the advantage that it can be changed without significantly affecting other rivet properties. Thus, for example when conducting joining trails on a particular workpiece combination, if the rivet depicted in FIG. 1 is not flaring sufficiently to form a strong joint, then the rivet depicted in FIG. 2 may be used instead. The rivet can be generally expected to behave in the same way, except that more flaring of the rivet will be seen.

When a tubular rivet is used, this pressure effect does not arise because the material can continue to flow up into the bore rivet. Consequently, flaring of the shank is not promoted by the resulting pressure that would normally arise. Consequently, a tubular rivet may be used when it is desirable for the rivet shank to flare at a later point during insertion into a workpiece. Conversely, if earlier flaring is desired then a rivet with a shorter bore depth BD may be preferred.

The length of the rivet shank may be smaller as a function of the workpiece thickness than is the case in conventional joints. In general, it is conventionally understood that a rivet should be 1-2 mm longer than the thickness of the material being joined. However, in embodiments of the invention the rivet may be between 0.9 mm and 1.2 mm longer than the material being joined. This reflects an improved understanding of what is needed to provide a good joint. In particular, it is now understood that the rivet does not need to penetrate as far into the lower layer of a workpiece.

A rivet according to an embodiment of the invention may be used to join 7000 series high strength aluminium alloy (e.g. 7075 aluminium alloy). A rivet according to an embodiment of the invention may be used to join 6000 series high strength aluminium alloy. Combinations of these may be joined together.

A rivet according to an embodiment of the invention may be formed from manganese boron steel (36MnB4). Other suitable steels may be used to form the rivet.

Although embodiments of the invention have been described as having a head diameter HD of up to 5.5 mm, in some instances a larger head diameter may be used. For example, a larger head diameter may be used when joining high strength aluminium if a top layer of the workpiece is soft aluminium.

In some pictures of joints formed using embodiments of the invention, the rivet head may appear not to have a flat underside portion. However, all rivets according to embodiments of the invention that were used to form the pictured joints included a flat head underside portion prior to insertion into the workpiece. In some instances, the workpiece may have pushed an outer periphery of the head upwards during rivet insertion such that the head underside portion is no longer flat.

Dimensions referred to above may include some tolerance, e.g. arising from manufacturing variation. In general, a rivet dimension referred to above may have a tolerance of ±10%. That is, the dimension may be up to 10% greater than the value stated and up to 10% less than the value stated. Other tolerances may apply.

Dimensions set out above are without low friction plating (i.e. before low friction plating, if present, has been applied to the rivet). A low friction plating may be applied to the rivet to make it easier for the rivet to travel into high strength aluminium. Additionally or alternatively, a lubricant may be applied to the rivet for the same reason.

1. A self-piercing rivet for joining high strength aluminium, the rivet comprising a head and a shank which is provided with a bore, wherein the shank has a diameter D1 of between 3.6 mm and 4.4 mm, and wherein a tip of the shank is separated by a radial distance Tx of least 0.2 mm from an outer diameter of the shank.

2. The self-piercing rivet of claim 1, wherein the radial distance Tx is at least 0.165 mm plus 0.01 multiplied by an effective length of the rivet.

3. The self-piercing rivet of claim 1, wherein the radial distance Tx is up to 0.25 mm plus 0.005 multiplied by an effective length of the rivet.

4. The self-piercing rivet of claim 1, wherein the shank has a thickness LT of at least 0.8 mm.

5. The self-piercing rivet of claim 1, wherein a ratio of shank diameter/inner shank diameter D2/D1 is at least 0.5.

6. The self-piercing rivet of claim 1, wherein the inner shank diameter D2 is at least 1.8 mm.

7. The self-piercing rivet of claim 1, wherein a ratio of shank thickness/shank diameter is greater than 0.66.

8. The self-piercing rivet of claim 1, wherein a tip of the shank does not include a flat ring which extends fully around the tip of the rivet.

9. The self-piercing rivet of claim 1, wherein the shank diameter D1 is at least 3.4 mm plus 0.0471 multiplied by the effective length LE of the self-piercing rivet.

10. The self-piercing rivet of claim 1, wherein the shank diameter D1 is up to 3.8 mm plus 0.0471 multiplied by the effective length LE of the self-piercing rivet.

11. The self-piercing rivet of claim 1, wherein a piercing end of the rivet includes a radiussed portion having a ratio of radius R2/shank thickness LT of at least 0.66.

12. A self-piercing rivet for joining high strength aluminium, the rivet comprising a head and a shank which is provided with a bore, wherein the shank has a diameter D1 of between 3.6 mm and 4.4 mm, and wherein the rivet head includes a substantially flat underside portion.

13. The self-piercing rivet of claim 12, wherein the substantially flat underside portion of the head extends radially by at least 0.15 mm.

14. The self-piercing rivet of claim 12, wherein the rivet head has a thickness HT of up to 0.5 mm.

15. The self-piercing rivet of claim 12, wherein a radiussed transition between the rivet head and the shank has a radius R1 of 0.6 mm or less.

16. The self-piercing rivet of claim 12, wherein the rivet head has a diameter HD of 5.5 mm or less.

17. A joint formed in a workpiece comprising at least two layers of high strength aluminium alloy, wherein the joint is formed using a self-piercing rivet having a shank with a diameter D1 prior to insertion into the workpiece of between 3.6 mm and 4.4 mm.

18. The joint of claim 17, wherein a tip of the shank is separated by a radial distance Tx of least 0.2 mm from an outer diameter of the shank prior to insertion.

19. The joint of claim 17, wherein the rivet head includes a substantially flat underside portion prior to insertion.

20. A method of forming a joint comprising inserting a rivet into at least two layers of high strength aluminium, wherein the self-piercing rivet has a shank with a diameter of between 3.6 mm and 4.4 mm, wherein the workpiece is at room temperature and wherein the rivet is inserted into the workpiece using a force of 50 kN or less.
